(19) United States
(12) Patent Application Publication
(10) Pub. No.: US 2017/0106600 A1
(43) Pub. Date: Apr. 20, 2017

(54) Method of Manufacturing a Product at or on-route to a Point of Delivery with a Single-Dimensional or Multi-Dimensional Printer

(71) Applicant: Ron Sostek, Newton, MA (US)

(72) Inventor: Ron Sostek, Newton, MA (US)

(21) Appl. No.: 15/295,843

(22) Filed: Oct. 17, 2016

Related U.S. Application Data
(60) Provisional application No. 62/242,154, filed on Oct. 15, 2015.

(51) Int. Cl. B29C 67/00; G05B 17/02; G06Q 10/08; B33Y 10/00; B33Y 50/02

(52) U.S. Cl. CPC B29C 67/0088; B33Y 10/00; B33Y 50/02; G06Q 10/083; G05B 17/02; G05B 2219/49023

(57) ABSTRACT

A method of manufacturing a product at or on-route to a point of delivery in order to eliminate shipments of pre-made products from remote manufacturing sites are implemented through a manned or unmanned transportation vehicle, a multi-axis printer (with the necessary servo mechanisms or services to complete the product), and a central computing device. The transportation vehicle provides the mean of transportation to the multi-axis printer from one location to another as the multi-axis printer is able to output a final product in accordance to consumer requirements. The central computing device is communicably coupled with the multi-axis printer and the transportation vehicle to execute a manufacture request that provides the specifications of the final product. Once the final product is constructed, the multi-axis printer performs at least one reliability test for the final product to insure the proper functionality and the structural integrity of the final product.

The current application claims a priority to the U.S. Provisional Patent application Ser. No. 62/242,154 filed on Oct. 15, 2015. The current application is filed on Oct. 17, 2015 while Oct. 15, 2015 was on a weekend.

### FIELD OF THE INVENTION

The present invention generally relates to manufacturing a product via a multi-dimensional printer. More specifically, the present invention is a method of manufacturing a product at or on-route to a point of delivery in order to eliminate shipments of pre-made products from remote manufacturing sites.

### BACKGROUND OF THE INVENTION

Generally, products are manufactured and assembled at manufacturing facilities and shipped to storefronts or other sales locations as product inventory for potential sales. Then, a consumer is able purchase those products upon their discretion. Once the sale is completed, the consumer can transport the purchased products or have a sales agent shipped the purchased product for a shipping fee. The final price of the product is determined by the sales agent so that a sufficient profit margin can be attained for all parties involved in the aforementioned process. Resultantly, the consumer pays a higher price for the purchased products. Products are manufactured in remote sites and shipped to the use site or sales site from an inventory in pieces to be assembled or in complete format. These cost and time to get from remote manufacturing to end user is s significant. This new concept removes these assembly issues and transportation and stocking large physical inventories.

It is an objective of the present invention to eliminates the remote manufacturing facilities, shipping costs, and product inventory so that the consumer is able to purchase the same product for a lower price compared to the aforementioned process in a faster time frame. Manufacturing finished products (ex. cars, band-aides, scientific glassware, shirts, dresses, food goods such as corn beef and baloney, mails, screws, circuit boards, automobile parts, lotion tubes, ointment tubes, medicines, furniture, cars, trucks, pants, breads, service parts) in a direct point of sales facility, point of use, or point of delivery with a multi-dimensional printer. The present invention eliminates manufacturing facilities and ship methods to a location of use, a store front or residence or place of use. More specifically, an actual product is printed in a dwelling where consumer lives or a store front that traditionally sells the actual product after being shipped from the remote manufacturing facility or in the field or at the site of use. The multi-dimensional printer and software are designed for industrial use. The multi-dimensional printer has simpler user interface that directly prints out a final product at the point of delivery or site of use, dramatically reducing inventories and eliminating specialized operators for the multi-dimensional printer. The multi-dimensional printer also dramatically reduces the number of vendors that are needed to complete a product. The multi-dimensional printer may be augmented with mechanical, electrical, robotics to assist in the assembly. These will be different for different products The multidimensional printers can be brought to a site by unattended drones on land, sea, and air. The product can be printed at the sire for use or sale.

### BRIEF DESCRIPTION OF THE DRAWINGS

FIG. 1 is a basic flow chart illustrating the overall process of the present invention.

FIG. 2 is a basic flow chart illustrating the uploading process of external computer-aided design (CAD) file within the overall process of the present invention.

FIG. 3 is a basic flow chart illustrating the uploading process of image file within the overall process of the present invention.

FIG. 4 is a basic flow chart illustrating the uploading process of internal CAD file within the overall process of the present invention.

FIG. 5 is a basic flow chart illustrating the similar final products within the overall process of the present invention, wherein the printer is situated at the same location.

FIG. 6 is a basic flow chart illustrating the different final products within the overall process of the present invention, wherein the printer is situated at the same location.

FIG. 7 is a basic flow chart illustrating the different final products within the overall process of the present invention, wherein the printer is situated at two different locations.

FIG. 8 is a basic flow chart illustrating the overall process of the present invention, wherein the final product includes multiple components.

FIG. 9 is a basic flow chart illustrating the stress and strain analysis within the overall process of the present invention.

FIG. 10 is a basic flow chart illustrating the functionality analysis within the overall process of the present invention.

### DETAIL DESCRIPTIONS OF THE INVENTION

All illustrations of the drawings are for the purpose of describing selected versions of the present invention and are not intended to limit the scope of the present invention.

In general, the present invention is a method of manufacturing a product at or on-route to a point of delivery for use or sales with a single-dimensional to multi-dimensional printer that is integrated into a system with servo robotics, services, quality control diagnostics, easy-to-use preprogrammed software eliminating remote factories, remote inventories, large parts acquisition from multiple vendors, transportation, and software engineers to modify program.

More specifically, a product can be constructed with variety of different manufacturing methods, such as weaving, molding, welding, and printing via manufacturing sites. If the product contains a plurality of components, each component is manufactured and then assembled together. Finally, the product is tested for industry standard specifications and shipped to a vendor to be purchased by the customers. The three dimensional (3D) printers have become a major manufacturing device within the manufacturing industry as the 3D printers provide flexibility and customization for the constructed products. The traditional 3D printers are generally operated by engineers due to the complexity of the 3D printers' user interface and the requirement of computer-aided design (CAD) files. However, the present invention is able to eliminate multiple vendors and manufacturing sites from the aforementioned manufacturing process. More specifically, the present invention is a method of manufacturing a product at or on-route to a point of delivery in order to eliminate shipments of pre-made products from remote manufacturing sites, wherein the present invention is implemented through a transportation vehicle, a multi-axis printer, and a central computing device. The final product can include, but is not limited to, cloths, shoes, medicines, medical equipment, food items, vehicles, electrical components, outer wears, and furniture.

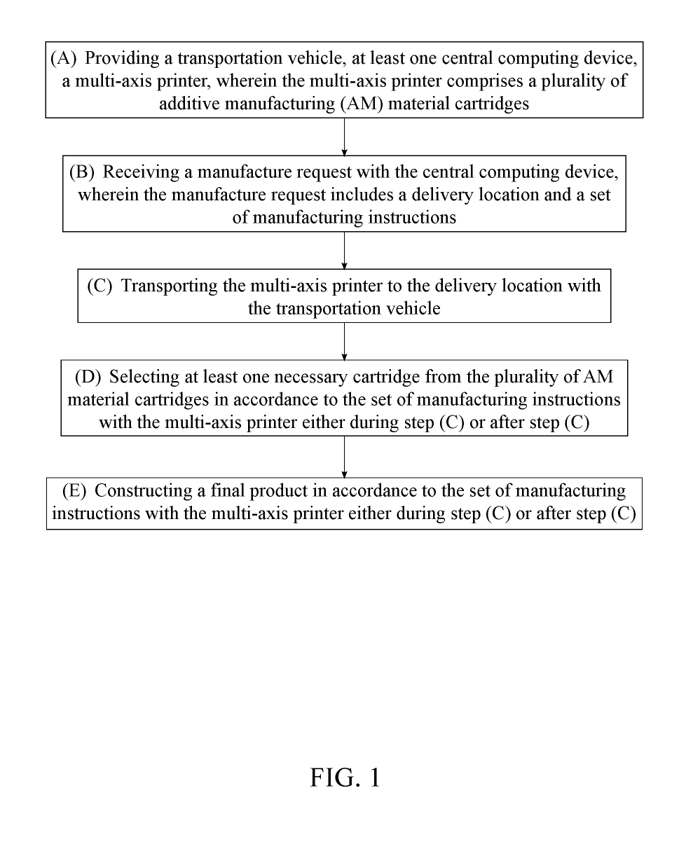

In reference to FIG. 1, the transportation vehicle is designated to transport the multi-axis printer from one location to another. For example, the transportation vehicle can be any type of unmanned aerial vehicle, unmanned ground vehicle, manned aerial vehicle, or manned ground vehicle. An unmanned transportation vehicle is particularly useful for the present invention because a product can be manufactured on-route or at inhabitable areas for humans such as very far offshore in an ocean or in space. Products that could be brought to or made at these inhabitable areas include, but are not limited to, radio towers, weather monitoring equipment, and ocean buoys. The multi-axis printer can be macro level, micro level, or atomic level as each different level associated with the configuration and size of the final product. The multi-axis printer comprises a plurality of additive manufacturing (AM) material cartridges to construct the final product and packaging if necessary at the point of delivery. Since the final product is constructed at the point of delivery, the present invention does not require to maintain any kind of component inventory other than the plurality of AM material cartridges. The central computing device is communicably coupled to a user interface that is associated with a consumer, the transportation vehicle, and the multi-axis printer so that information within the present invention can be transmitted between those entities. More specifically, when the user interface submits information according to consumer requirements, the central computing device transmits the submitted information to either the transportation vehicle, the multi-axis printer, or both the transportation vehicle and the multi-axis printer to construct the final product.

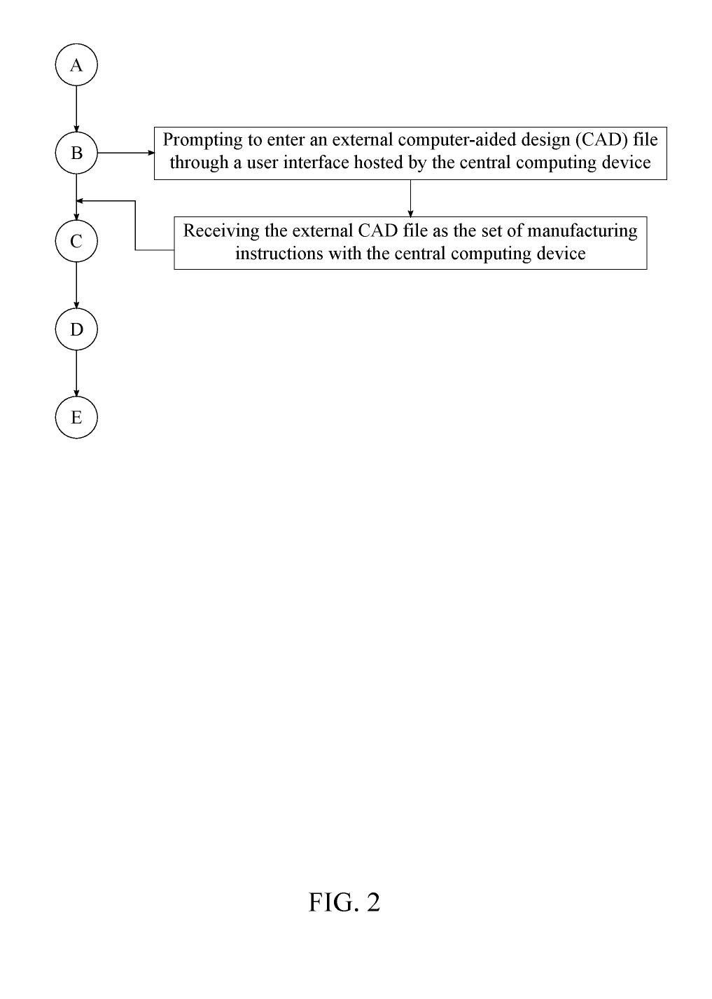

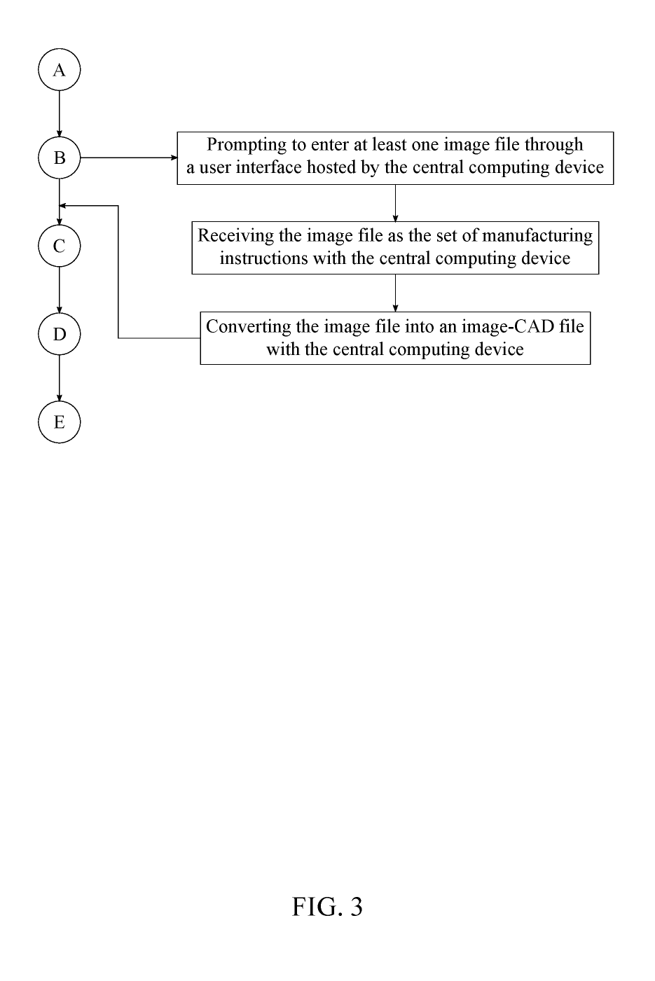

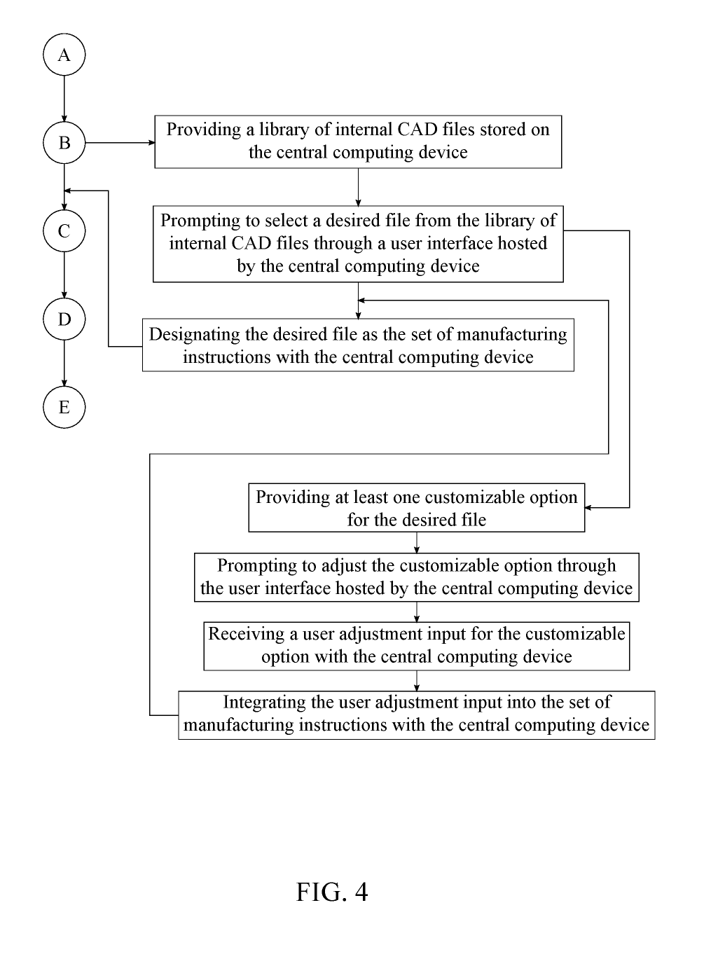

In order to initiate the present invention, the central computing device first requires to receive a manufacture request that comprises a delivery location and a set of manufacturing instructions as shown in FIG. 1. The delivery location can be a store front, a personal address, a business address, or another physical location that the multi-axis printer can be stationed. The set of manufacturing instructions is directly related to the final product and comprise CAD file data, material selection, product dimensions, product color, specific outputs, product quantity, and any other information that is related to the structural integrity, functionality, and the esthetic appearance of the final product. The set of manufacturing instructions can be uploaded to the multi-axis printer with two different methods upon user's discretion. In reference to one method of uploading the manufacturing instructions, the consumer is prompted to enter an external CAD file through the user interface hosted by the central computing device as shown in FIG. 2. As a result, the central computing device uploads the external CAD file into the multi-axis printer as the manufacturing instructions. Then, the multi-axis printer is able to construct the final product through the external CAD file. In reference to another method of uploading the manufacturing instructions, the consumer is prompted to enter at least one image file through the user interface hosted by the central computing device as shown in FIG. 3. The central computing device then converts the image file into an image-CAD file and uploads the image-CAD file into the multi-axis printer as the manufacturing instructions. Then, the multi-axis printer is able to construct the final product through the external CAD file. In reference to another method of uploading the manufacturing instructions, the consumer is able to select a desired file to be constructed from a library of internal CAD files through the user interface hosted by the central computing device as shown in FIG. 4. The central computing device then designates the desired file as the manufacturing instructions and uploads the desired file into the multi-axis printer.

When the consumer is selecting a pre-programmed CAD file from the library of internal CAD files, the present invention additionally allows the desired file to be modified or customized according to the consumer requirements as shown in FIG. 4. More specifically, when the desired file is selected as the manufacturing instructions, the present invention further presents at least one customizable option for the desired file and prompts to adjust the customizable option through the user interface hosted by the central computing device. Then, the present invention receives a user adjustment input for the customizable option and integrates the user adjustment input into the set of manufacturing instructions with the central computing device. For example, when a consumer requests pepperoni slices through the present invention, the consumer is able to determine meat proportions, spice proportions, salt proportion, and fat proportion according to consumer's requirements before the pepperoni slices are constructed.

In reference to FIG. 1, when the manufacturing request is completed with the central computing device, the present invention transports the multi-axis printer to the delivery location with the transportation vehicle. Depending upon the complexity and the set of manufacturing instructions of the final product, the multi-axis printer selects at least one necessary cartridge from the plurality of AM material cartridges in accordance to the set of manufacturing instructions during the transportation phase or after the transportation phase. The present invention then constructs the final product in accordance to the set of manufacturing instructions via the multi-axis printer. More specifically, if the necessary cartridge is selected during the transportation phase, the present invention initiates the construction process of the final product during the transportation phase. However, if the necessary cartridge is selected after the transportation phase, the present invention initiates the construction process of the final product after the transportation phase. For example, when the desired file is a sandwich, the present invention selects the necessary cartridges for bread, sandwich meat, spices, lattice, tomatoes, dressings, cheese, and other related sandwich ingredients to print the entire sandwich at the delivery location. As a result, the entire sandwich is constructed with the multi-axis printer as a single vendor, wherein the consumer is also able to integrate the user adjustment input.

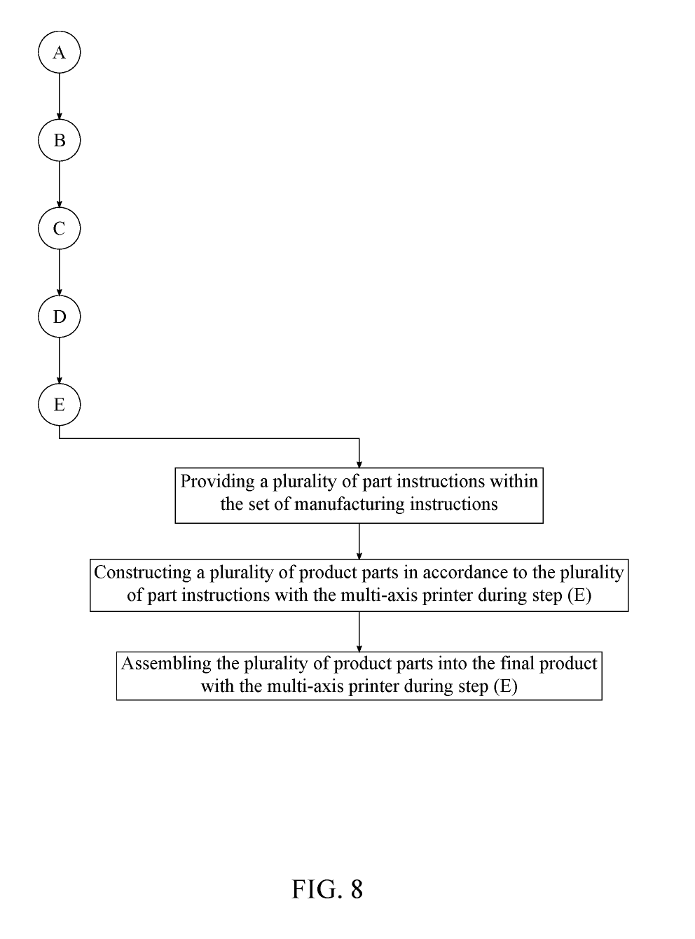

In reference to FIG. 8, if the central computing device receives a plurality of part instructions within the set of manufacturing instructions, the present invention individually constructs a plurality of product parts. More specifically, the plurality of product parts is configured in accordance to the plurality of part instructions and constructed via the multi-axis printer during the construction process of the final product. The plurality of product parts is then assembled into the final product with the multi-axis printer, wherein the multi-axis printer utilizes a robotic assembly system to assemble the plurality of product parts into the final product. The robotic assembly system may include, but is not limited to, integrated servo robotics, grinding components, welding components, sterilizing components, and spraying components. The robotic assembly system may also be capable of performing a variety of services such as assembly sterilization.

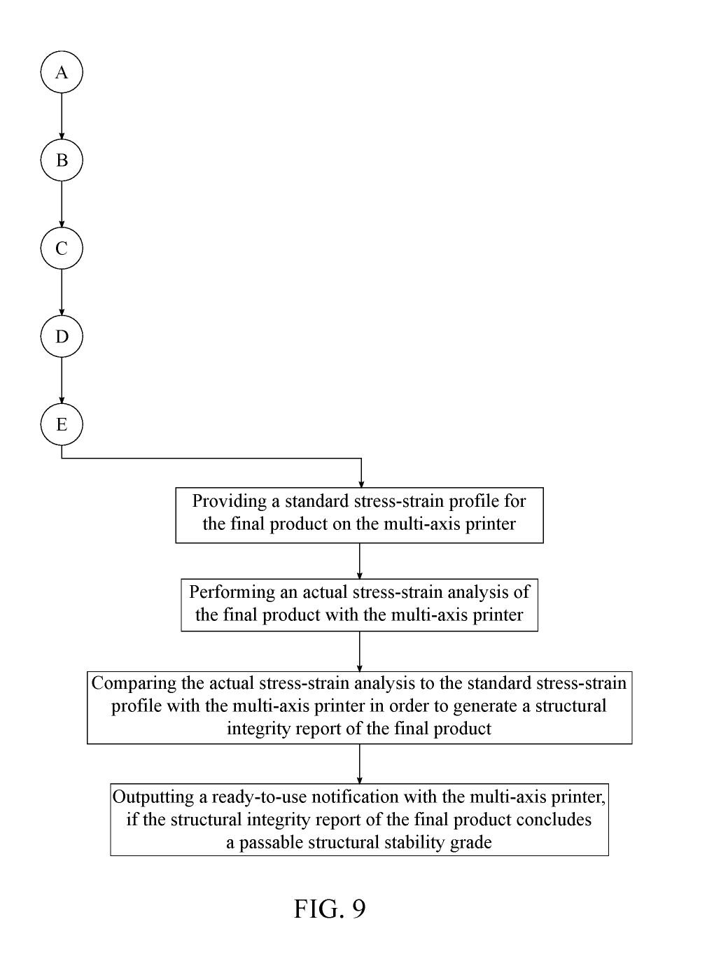

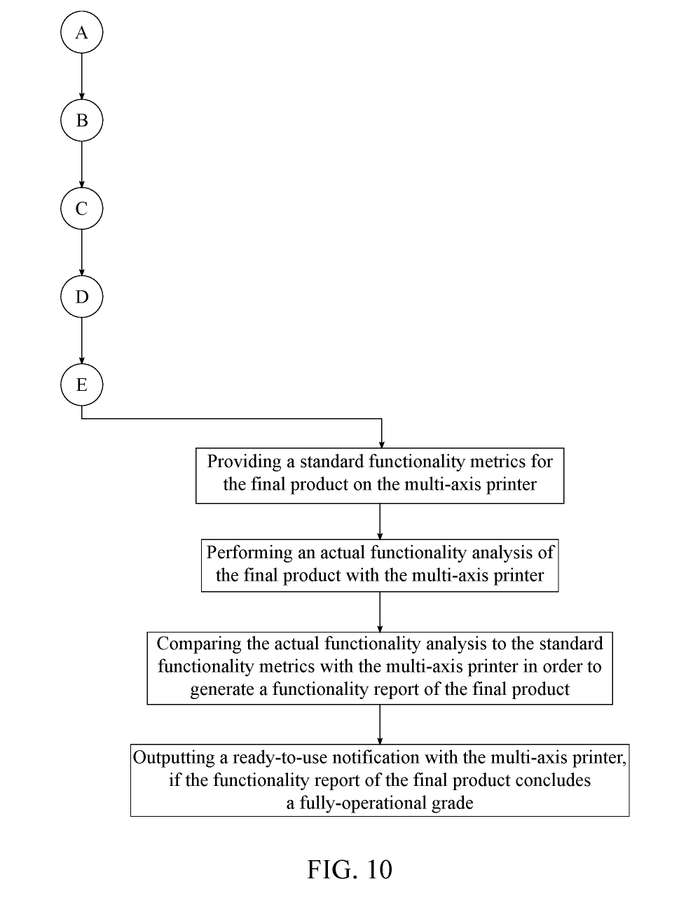

In reference to FIG. 9-10, when the final product is constructed within the present invention, the multi-axis printer performs at least one quality control test to insure the reliability of the final product. More specifically, the multi-axis printer is capable of performing a stress and strain analysis test and/or a functionality test. For example, when the final product is a single component and does not have any moving components, the respective final product only requires a stress and strain test to determine the reliability factor. However, when the final product includes multiple components and have moving components, the respective final product requires a stress and strain test for each component and a functionality test for the assembly of the final product to determine the reliability factor. In the event of executing the stress and strain test, the multi-axis printer is provided with a standard stress-strain profile for the final product and is also capable of performing an actual stress-strain analysis of the final product. Then, the standard stress-strain profile is compared with the actual stress-stain analysis to generate a structural integrity report for the final product. Once the structural integrity report is created, the multi-axis printer outputs a ready-to-use notification if the structural integrity report of the final product concludes a passable structural stability grade. In the event of executing the functionality test, the multi-axis printer is provided with standard functionality metrics for the final product and is also capable of performing an actual functionality analysis of the final product. Then, the standard functionality metrics are compared with the actual functionality analysis to generate a functionality report for the final product. Once the functionality report is created, the multi-axis printer outputs a ready-to-use notification if the functionality report of the final product concludes a fully-operational grade. The present invention is capable of performing a variety of other diagnostic tests as well, which include, but is not limited to, tensile testing, hardness testing, and light illumination testing to locate cracks. These diagnostic tests and testing sensors for the present invention are used to assess the quality of the final product.

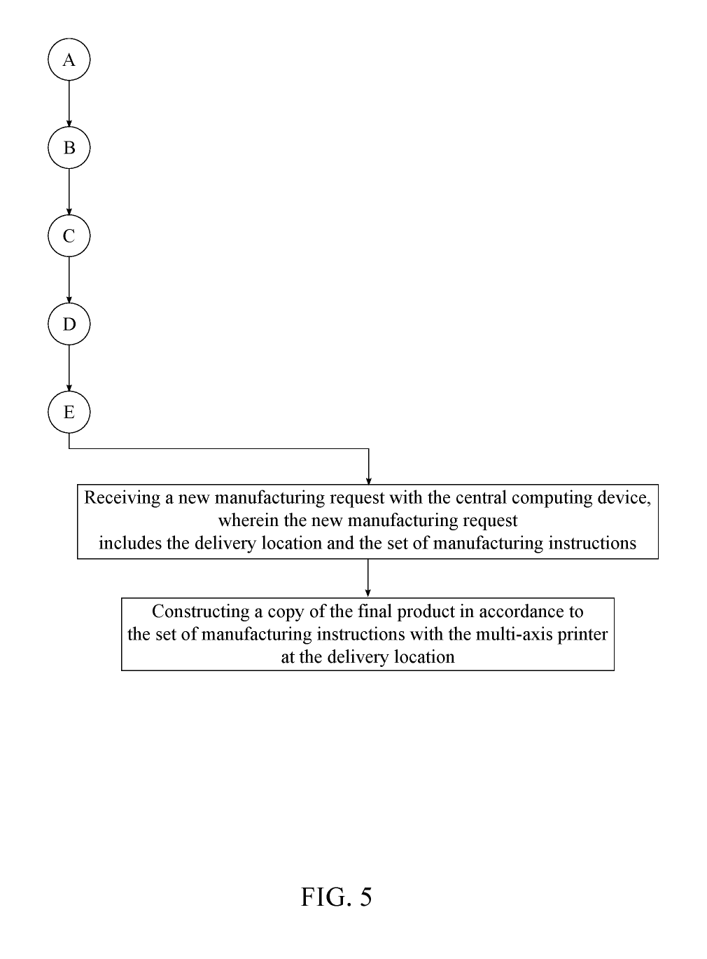

In reference to FIG. 5, when the central computing device receives a new manufacture request that comprises the delivery location and the set of manufacturing instructions, the present invention concludes that the multi-axis printer does not have to be moved from the current location since the manufacturing request and the new manufacturing request share the same delivery location. Additionally, the present invention also concludes that the manufacturing request and the new manufacture request comprise same set of manufacturing instructions. As a result, the multi-axis printer once again selects the necessary cartridge from the plurality of AM material cartridges in accordance to the set of manufacturing instructions at the delivery location. The multi-axis printer then constructs a copy of the final product in accordance to the set of manufacturing instructions at the delivery location. For example, a sandwich shop first constructs a ham sandwich as the final product with respect to the manufacture request. Then, a second ham sandwich is also constructed as the copy of the final product with respect to the new manufacture request. Since the same sandwich shop constructs both ham sandwiches at the delivery location, the multi-axis printer does not have to be transported from the initial location to another location.

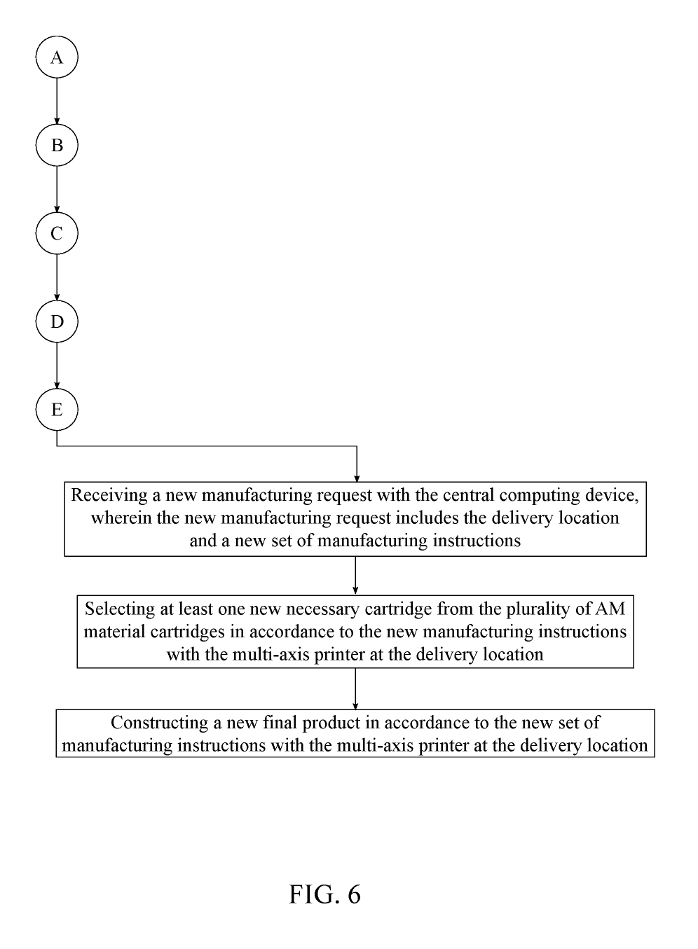

In reference to FIG. 6, when the central computing device receives a new manufacture request that comprises the delivery location and a new set of manufacturing instructions, the present invention concludes that the multi-axis printer does not have to be moved from the current location since the manufacturing request and the new manufacturing request share the same delivery location. Once the new manufacturing request is completed with the central computing device, the multi-axis printer selects at least one new necessary cartridge from the plurality of AM material cartridges in accordance to the new set of manufacturing instructions at the delivery location. The multi-axis printer then constructs a new final product in accordance to the new set of manufacturing instructions at the delivery location. For example, a sandwich shop constructs a ham sandwich as the final product and then constructs a turkey sandwich as a new final product. Since the same sandwich shop constructs the ham sandwich and the turkey sandwich at the delivery location, the multi-axis printer does not have to be transported from the initial location to another location.

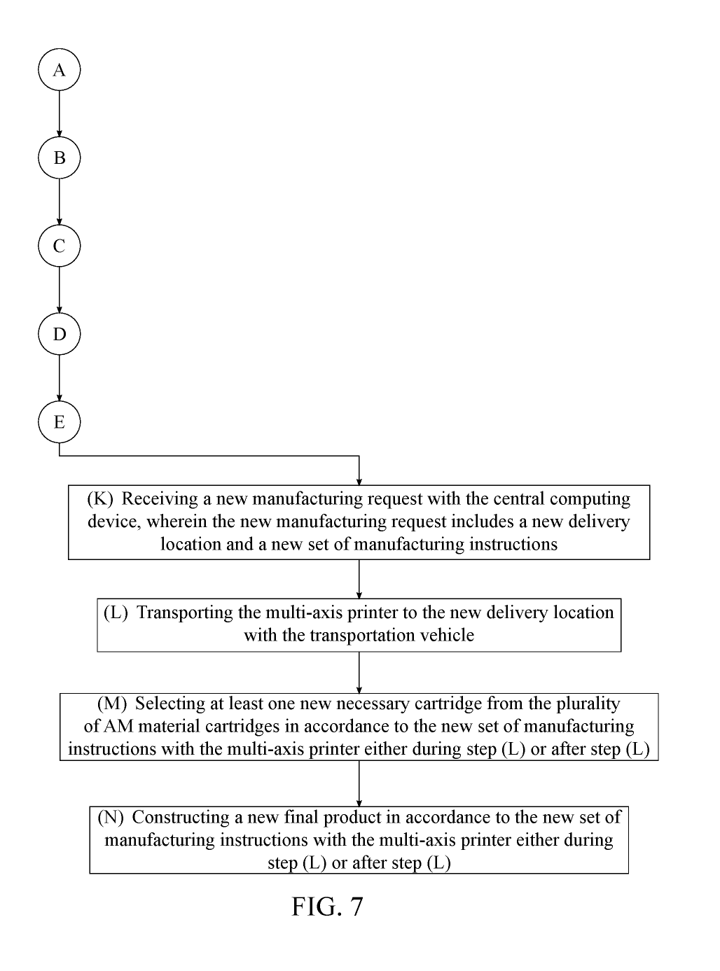

In reference to FIG. 7, when the central computing device receives a new manufacture request that comprises a new delivery location and a new set of manufacturing instructions, the present invention concludes that the multi-axis printer has to be moved from the current location since the manufacturing request and the new manufacturing request does not share the same delivery location. Once the new manufacturing request is completed with the central computing device, the transportation vehicle transports the multi-axis printer to the new delivery location. The multi-axis printer then selects at least one new necessary cartridge from the plurality of AM material cartridges in accordance to the new set of manufacturing instructions during the transportation phase or after the transportation phase. The multi-axis printer then constructs a new final product in accordance to the new set of manufacturing instructions. More specifically, if the necessary cartridge is selected during the transportation phase, the present invention initiates the construction process of the new final product during the transportation phase. However, if the necessary cartridge is selected after the transportation phase, the present invention initiates the construction process of the new final product after the transportation phase.

The multi-axis printer can optionally store a plurality of natural elements, such as diamonds, pearl, animal leather, and precious stones. As a result, if the final product requires a specific natural element from the plurality of natural elements during the construction process, the multi-axis printer is able to select and incorporate the specific natural element into the final product.

Although the invention has been explained in relation to its preferred embodiment, it is to be understood that many other possible modifications and variations can be made without departing from the spirit and scope of the invention as hereinafter claimed.

What is claimed is:

1. A method of manufacturing a product at or on-route to a point of delivery for use or sales with a single to multidimensional printer integrated into a system with servo robotics, services, quality control diagnostics, easy-to-use preprogrammed software eliminating remote factories, remote inventories, large parts acquisition from multiple vendors, transportation, and software engineers to modify program.

2. A method of manufacturing a product at or on-route to a point of delivery with a single-dimensional or multi-dimensional printer, the method comprises the steps of:
(A) providing a transportation vehicle, at least one central computing device, a multi-axis printer, wherein the multi-axis printer comprises a plurality of additive manufacturing (AM) material cartridges;
(B) receiving a manufacture request with the central computing device, wherein the manufacture request includes a delivery location and a set of manufacturing instructions;
(C) transporting the multi-axis printer to the delivery location with the transportation vehicle;
(D) selecting at least one necessary cartridge from the plurality of AM material cartridges in accordance to the set of manufacturing instructions with the multi-axis printer either during step (C) or after step (C); and
(E) constructing a final product in accordance to the set of manufacturing instructions with the multi-axis printer either during step (C) or after step (C).

3. The method of manufacturing a product at or on-route to a point of delivery with a single-dimensional or multi-dimensional printer, the method as claimed in claim 2 comprises the steps of:
prompting to enter an external computer-aided design (CAD) file through a user interface hosted by the central computing device; and
receiving the external CAD file as the set of manufacturing instructions with the central computing device.

4. The method of manufacturing a product at or on-route to a point of delivery with a single-dimensional or multi-dimensional printer, the method as claimed in claim 2 comprises the steps of:
prompting to enter at least one image file through a user interface hosted by the central computing device;
receiving the image file as the set of manufacturing instructions with the central computing device; and
converting the image file into an image-CAD file with the central computing device.

5. The method of manufacturing a product at or on-route to a point of delivery with a single-dimensional or multi-dimensional printer, the method as claimed in claim 2 comprises the steps of:
providing a library of internal CAD files stored on the central computing device;
prompting to select a desired file from the library of internal CAD files through a user interface hosted by the central computing device; and
designating the desired file as the set of manufacturing instructions with the central computing device.

6. The method of manufacturing a product at or on-route to a point of delivery with a single-dimensional or multi-dimensional printer, the method as claimed in claim 5 comprises the steps of:
providing at least one customizable option for the desired file;
prompting to adjust the customizable option through the user interface hosted by the central computing device;
receiving a user adjustment input for the customizable option with the central computing device; and
integrating the user adjustment input into the set of manufacturing instructions with the central computing device.

7. The method of manufacturing a product at or on-route to a point of delivery with a single-dimensional or multi-dimensional printer, the method as claimed in claim 2 comprises the steps of:
(F) receiving a new manufacturing request with the central computing device after step (E), wherein the new manufacturing request includes the delivery location and the set of manufacturing instructions; and
(G) constructing a copy of the final product in accordance to the set of manufacturing instructions with the multi-axis printer at the delivery location.

8. The method of manufacturing a product at or on-route to a point of delivery with a single-dimensional or multi-dimensional printer, the method as claimed in claim 2 comprises the steps of:
(H) receiving a new manufacturing request with the central computing device after step (E), wherein the new manufacturing request includes the delivery location and a new set of manufacturing instructions;
(I) selecting at least one new necessary cartridge from the plurality of AM material cartridges in accordance to the new manufacturing instructions with the multi-axis printer at the delivery location; and
(J) constructing a new final product in accordance to the new set of manufacturing instructions with the multi-axis printer at the delivery location.

9. The method of manufacturing a product at or on-route to a point of delivery with a single-dimensional or multi-dimensional printer, the method as claimed in claim 2 comprises the steps of:
(K) receiving a new manufacturing request with the central computing device after step (E), wherein the new manufacturing request includes a new delivery location and a new set of manufacturing instructions;
(L) transporting the multi-axis printer to the new delivery location with the transportation vehicle;
(M) selecting at least one new necessary cartridge from the plurality of AM material cartridges in accordance to the new set of manufacturing instructions with the multi-axis printer either during step (L) or after step (L); and
(N) constructing a new final product in accordance to the new set of manufacturing instructions with the multi-axis printer either during step (L) or after step (L).

10. The method of manufacturing a product at or on-route to a point of delivery with a single-dimensional or multi-dimensional printer, the method as claimed in claim 2 comprises the steps of:
providing a plurality of part instructions within the set of manufacturing instructions;
constructing a plurality of product parts in accordance to the plurality of part instructions with the multi-axis printer during step (E); and
assembling the plurality of product parts into the final product with the multi-axis printer during step (E).

11. The method of manufacturing a product at or on-route to a point of delivery with a single-dimensional or multi-dimensional printer, the method as claimed in claim 2 comprises the steps of:
providing a standard stress-strain profile for the final product on the multi-axis printer;
performing an actual stress-strain analysis of the final product with the multi-axis printer after step (E);
comparing the actual stress-strain analysis to the standard stress-strain profile with the multi-axis printer in order to generate a structural integrity report of the final product; and
outputting a ready-to-use notification with the multi-axis printer,
if the structural integrity report of the final product concludes a passable structural stability grade.

12. The method of manufacturing a product at or on-route to a point of delivery with a single-dimensional or multi-dimensional printer, the method as claimed in claim 2 comprises the steps of:
providing standard functionality metrics for the final product on the multi-axis printer;
performing an actual functionality analysis of the final product with the multi-axis printer after step (E);
comparing the actual functionality analysis to the standard functionality metrics with the multi-axis printer in order to generate a functionality report of the final product; and
outputting a ready-to-use notification with the multi-axis printer,
if the functionality report of the final product concludes a fully-operational grade.
